(19) United States
(12) Patent Application Publication
(10) Pub. No.: US 2009/0234584 A1
(43) Pub. Date: Sep. 17, 2009

(54) DATA GATHERING, TRANSMISSION, INTEGRATION AND INTERPRETATION DURING COILED TUBING WELL TESTING OPERATIONS

(75) Inventors: Anna Marie Casey, New Orleans, LA (US); Hisham Abou El Azm, Paris (FR)

Correspondence Address: Schlumberger Technology Corporation, P. O. Box 425045, Cambridge, MA, 02142, US

(73) Assignee: SCHLUMBERGER TECHNOLOGY CORPORATION, Cambridge, MA (US)

(21) Appl. No.: 12/045,782

(22) Filed: Mar. 11, 2008

(51) Int. Cl. G01V 9/00

(52) U.S. Cl. 702/12

(57) ABSTRACT

A method for calculating a property of a formation using one or more sensors lowered into a well on coiled tubing and surface well testing equipment that includes recording flow rate data using the surface well testing equipment; recording downhole pressure data using the one or more sensors lowered into a wellbore penetrating the formation on coiled tubing; transmitting the flow rate and downhole pressure measurements to a server, wherein the server is capable of collecting, storing and retransmitting the measurements; and transmitting the measurements to a processing unit, wherein the processing unit analyzes the measurements and calculates a property of the formation. Also an apparatus for calculating a property of a formation that includes a coiled tubing unit having one or more sensors capable of being lowered into a wellbore and measuring downhole pressures; surface well testing equipment capable of measuring flow rate data; means for transmitting the downhole pressure and flow rate measurements to a server capable of collecting, storing, and retransmitting the measurement data; and means for transmitting the measurements to a processing unit capable of calculating the property of the formation. A related method of servicing a hydrocarbon well is also disclosed.

### FIELD OF THE INVENTION

This invention is generally related to the testing of hydrocarbon wells, and more particularly to methods and apparatus associated with the testing of hydrocarbon wells that utilize flow data measured on the surface and pressure data measured in a wellbore.

### BACKGROUND OF THE INVENTION

When a well is producing hydrocarbons to surface and its performance is not as expected, the well is often tested to determine the direct causation of this lack of flow rate. This is normally characterized by a dimensionless factor called skin, which quantifies the production efficiency of a formation. The wellbore damage or flow restriction must then be assessed to determine an appropriate method to treat the damage effectively. This damage can be the result of many conditions such as but not limited to solid or mud-filtrate invasion, perforating debris, inadequate perforations, near or far wellbore damage and low permeability formations. Stimulation methods such as fracturing or acidizing are typically used to increase production potential. Normally another test is performed after stimulation to evaluate the effectiveness of the treatment.

To properly treat a damaged well, we first need to understand the origin and nature of the damage. One way to achieve this is by analyzing well test data. One of the preferred methods used in well test interpretation is pressure transient analysis (also called “PTA”). This method combines flow rate and bottomhole pressure measurements obtained by flowing the well through instruments at the surface and by recording the bottomhole pressure with the well shut-in. Both measurements (flowing and shut-in) are recorded at one or a plurality of time periods depending on the complexity of the study. The pressure and pressure derivative curves are compared to known type-curves to determine the skin and permeability. After the treatment is formulated and executed, a post stimulation test may be conducted to record a final skin.

Presently, testing and treating a well is a complex operation in which two services must typically be utilized; Coiled Tubing Services and Testing Services. The nature and logistics of these two services are such that they are not frequently performed concurrently. Coiled tubing is run in the well to be treated with a prepared stimulation program. After the coiled tubing stimulation operation is finished, the coiled tubing is retrieved to surface and the coiled tubing equipment is rigged down; it is only after rig-down that surface well testing operations are typically performed. At this stage, a surface well test is conducted and the data is collected from two different sources; i.e. from surface and downhole sensors. The sensor data is combined and transmitted via satellite, internet, solid media (as example but not to limit this disclosure: CD, DVD, memory stick, floppy disks and the like) to a server for further transmittal to a data processing center for validation, interpretation, and modeling. This process often adds unnecessary cost and requires significant rig time.

To better understand the reservoir using surface well testing and coiled tubing stimulating services to optimize production, the two services can be integrated to offer a near real-time solution. The ability to evaluate, treat, and test a well with near real-time interpretation capabilities has been a long desired industry goal.

This can be accomplished by using enhanced Coiled Tubing Services as the means to stimulate and test a well. The coiled tubing is run down the well with a downhole assembly comprising one or more sensors and any other equipment and instruments needed during the well test. A packer (or set of packers) included in the coiled tubing bottomhole assembly is normally set above the formation, in the case of one packer or straddling the formation in the case of two packers. Included in this bottomhole assembly (referred to as a “BHA” and also known as a downhole assembly) are one or more gauges that are used to acquire the downhole pressure. The coiled tubing can now transport fluids to and from the well (allowing acidizing or fracturing fluids to be pumped into the well and allowing reservoir fluids from the well to flow to the surface, etc.) with the assistance of surface equipment where the flow rate is measured. To test, stimulate, and test again all through coiled tubing offers a great reduction in rig time and a much needed method to understand complex wells.

The efficiency of this type of operation typically relies on the mutual and multi-functional use of tools, but more importantly on the ability to integrate and interpret both downhole measurements and surface well test data efficiently. Testing a well, analyzing the information acquired to “customize” a treatment for that specific well, to further treat and test again to quantify the results of the treatment is a complex operation due to the different information platforms, software, data acquisition systems, and service companies, among other reasons. It is often in this complex operation that the most difficult action to accomplish is to offer a common medium or platform in which the data may be acquired, processed and interpreted to assess the well behavior. In some embodiments, the present invention proposes the combination of the coiled tubing pressure measurements and the surface well testing flow rate data be transmitted via the internet, satellite or any other means to perform near real-time interpretation of a well test during intervention, such interpretations at a practical level often comprising pressure transient analysis.

The most common conventional well testing operation is what is known in the industry as a drill stem test (“DST”). A DST operation typically utilizes a plurality of pressure sensors lowered into a well to be tested via a drill string; the pressure sensors are pressure gauges that record the downhole pressure in a memory media within the sensor. After the surface well test is completed, the drill string is recovered to surface and the downhole pressure data is read out of the downhole sensors. The downhole pressure data is integrated with the volumetric flow data recorded by the surface well test equipment and entered into the pressure transient analysis software. By the time this happens, many hours, sometimes days, have passed and the means that could be used to treat the well (i.e. the drill pipe) is typically no longer in place in front of the formation.

The use of coiled tubing as a mean to well test a particular formation is not new to the industry. Such operations are disclosed in several U.S. patents mentioned hereinafter and included in their entirety by reference such as: U.S. Pat. No. 5,287,741 entitled “Methods of Perforating and Testing Wells Using Coiled Tubing”, issued Feb, 22, 1994 to Schultz et al; U.S. Pat. No. 5,638,904 entitled “Safeguarded Method and Apparatus for Fluid Communication Using Coiled Tubing, With Application to Drill Stem Testing”, issued Jun. 17, 1997 to Misselbrook and Sask; U.S. Pat. No. 6,520,255 entitled “Method and apparatus for stimulation of multiple formation intervals”, issued on Feb. 18, 2003 to Randy C. Tolman et al; U.S. Pat. No. 6,959,763 entitled “Method and apparatus for integrated horizontal selective testing of wells”, issued on Nov. 1, 2005 to Hook and Ramsey; U.S. Pat. No. 6,675,892 entitled “Well Testing Using Multiple Pressure Measurements” issued on Jun. 13, 2004 to Fikri Kuchuk, et al.; and Published U.S. Patent Application No. 20070044960 entitled “Methods, systems and apparatus for coiled tubing testing” published on Mar. 1, 2007 on behalf of John Lovell et al.

The fact remains that data acquired by one or more coiled tubing pressure sensors and a surface well test flow rate sensor is not today easily integrated, such as to generate a near real-time report that proactively helps the oil companies decide the best course of action for the particular well being studied without multiple trips in the hole and long lead times.

The present invention aims to create a method for handling the data generated from a plurality of sources, specifically the data generated doing a well testing operation using surface well testing equipment and one or more sensors lowered into a wellbore on coiled tubing, and integrate the data, in order to generate a report in near real-time to help decide the course of action to be taken in a particular well for instance.

### SUMMARY OF THE INVENTION

One embodiment of the invention involves a method of calculating a property of a formation using one or more sensors lowered into a well on coiled tubing and surface well testing equipment that includes recording flow rate data measured using the surface well testing equipment; recording downhole pressure data measured using the one or more sensors lowered into a wellbore penetrating the formation on coiled tubing; transmitting the flow rate and downhole pressure measurements to a server, wherein the server is capable of collecting, storing and retransmitting the measurements; and transmitting the measurements to a processing unit, wherein the processing unit analyzes the measurements and calculates a property of the formation. Another embodiment of the invention involves an apparatus for calculating a property of a formation that includes a coiled tubing unit having one or more sensors capable of being lowered into a wellbore and measuring downhole pressures; surface well testing equipment capable of measuring flow rate data; means for transmitting downhole pressure and flow rate measurements to a server capable of collecting, storing, and retransmitting the measurement data; and means for transmitting the measurements to a processing unit capable of calculating the property of the formation. A further embodiment of the invention involves a method of servicing a hydrocarbon well using one or more pressure sensors lowered into a well on coiled tubing and surface well testing equipment that includes determining a property of a formation using flow data measured using the surface well testing equipment that has been integrated with pressure data measured using the one or more sensors lowered into the well penetrating the formation on the coiled tubing; treating the formation by pumping fluid into the formation using the coiled tubing; and repeating the determining of the property of the formation using flow data measured using the surface well testing equipment that has been integrated with pressure data measured using the one or more sensors lowered into a wellbore penetrating the formation on the coiled tubing; wherein the coiled tubing remains deployed within the well throughout the determining, treating, and repeating the determining processes. Additional objects and advantages of the invention will become apparent to those skilled in the art upon reference to the detailed description taken in conjunction with the provided figures.

### BRIEF DESCRIPTION OF THE DRAWINGS

The present invention is illustrated by way of example and not intended to be limited by the figures of the accompanying drawings in which like references indicate similar elements and in which:

FIG. 1 shows an example embodiment of the inventive data workflow;

FIG. 2 shows an example of the integration of hardware equipment from Coiled Tubing and Testing Services; and

FIG. 3 shows one embodiment of the present invention where the data flow is depicted in more detail.

### DETAILED DESCRIPTION OF THE INVENTION

Historically, pressure transient analysis is completed days or even weeks following the stimulation and well testing of a particular well. Some of the contributing factors to this time delay may be the remoteness of the well being tested, combining data sets from different sources, and synchronizing (same sampling time, for example) the data sets to be able to upload it into the interpretation software used. Well sites are often in remote locations far from the staff that will perform the interpretation and modeling. The data typically goes through an extensive process of transmittal, synchronization, validation, and integration, among other processes, before making its way to the staff that will interpret and model the data. Much time can be saved and efficiency to be gained by offering integrated downhole and surface data sets streamlined onto a processing unit with near real-time data updating.

The present invention can facilitate near real-time pressure transient analysis from at least two data sets. One data set is pressure data acquired from downhole sensors lowered into the well by coiled tubing that is transmitted to surface. The second is flow rate measurements taken from the surface well testing measuring equipment. These two data sets are transmitted in near real-time to a web server where the information is integrated to allow for a streamlining file to be downloaded off this server anywhere in the world that has network connectivity. A continuous data stream can then be downloaded onto any processing unit and into interpretation software. Other data sets can be used such as (but not to limit this disclosure) temperature, gas/oil ratio (also called “GOR”), water cut, gas cut, CO2 and H2S content among others. All of these data sets can be acquired downhole and/or at surface for further integration to other data sets.

A person in charge of processing, interpreting and modeling the data can then monitor the pressure and pressure derivative curves for a particular flow or build-up period as the testing progresses in near real-time. This data streamline from acquisition to analysis software can be the basis for a near real-time pressure transient analysis. In the derivative plot, it is important that the person processing the data have a clear indication that radial flow has been reached to be able to extract reservoir information and fluid properties. All of this interpretation can be achieved in near real-time to enhance the stimulation treatment and evaluation testing.

To accomplish near real-time pressure transient analysis, the coiled tubing downhole data and well testing data often goes through at least seven different phases: data acquisition, data transmission, data synchronization, data stream integration, re-transmission, file conversion and final interpretation. The data will typically be uploaded and downloaded to a server and run through different functional software to bring about near real-time analysis to better target, test, and treat the well.

In the present invention at least two data sets are needed to generate a pressure transient analysis; the data sets are downhole pressure and surface flow rate. The downhole pressure is gathered using one or more gauges lowered into the well on coiled tubing, the measurements made by the gauges may be transmitted to surface via a multitude of alternative means, as way of example and not to limit this disclosure a fiber optic cable or a telemetry cable can be used. These pressure measurements are typically stored in the coiled tubing acquisition software. The flow rates from the surface well testing are typically volumetric flow rates obtained from a multiphase flow meter or test separator via surface well testing acquisition software, but mass flow rates could alternatively be used with appropriate measurements or assumptions made regarding the densities of the measured fluids. This acquisition software converts the data sets into a format that can be transmitted as a data stream. One example of a type of format that will allow streamlined transmission is called Wellsite Information Transfer Standard Markup Language or “WITSML”. WITSML is a data format standard for transmitting technical data between organizations in the oil industry. The coiled tubing and well testing acquisition software are able to generate a data stream in the aforementioned format. The data can be uploaded onto a server via transmittal means such as the Internet, satellite, solid recording means (CD, DVD, memory sticks, etc) and wireless amongst other options.

The data integration server in turns combines, integrates, synchronizes, and stores the data sets from the various acquisition systems. The data may be accessed through a network interface anywhere by anyone who has the relevant authorization. The staff that will generate the interpretation and modeling of the well in the study can upload the streamed data located in the server onto a processing unit and the interpretation and modeling software can generate a report that may be updated in near real-time as the data is streamed.

The reports of the interpretation and modeling of the well being studied can then be updated and periodically distributed as needed.

The staff that may generate the interpretation and modeling report will typically consist of a person, group of persons or organization with reservoir engineering knowledge and/or sufficient software knowledge to generate a pressure transient analysis given the data sets mentioned above.

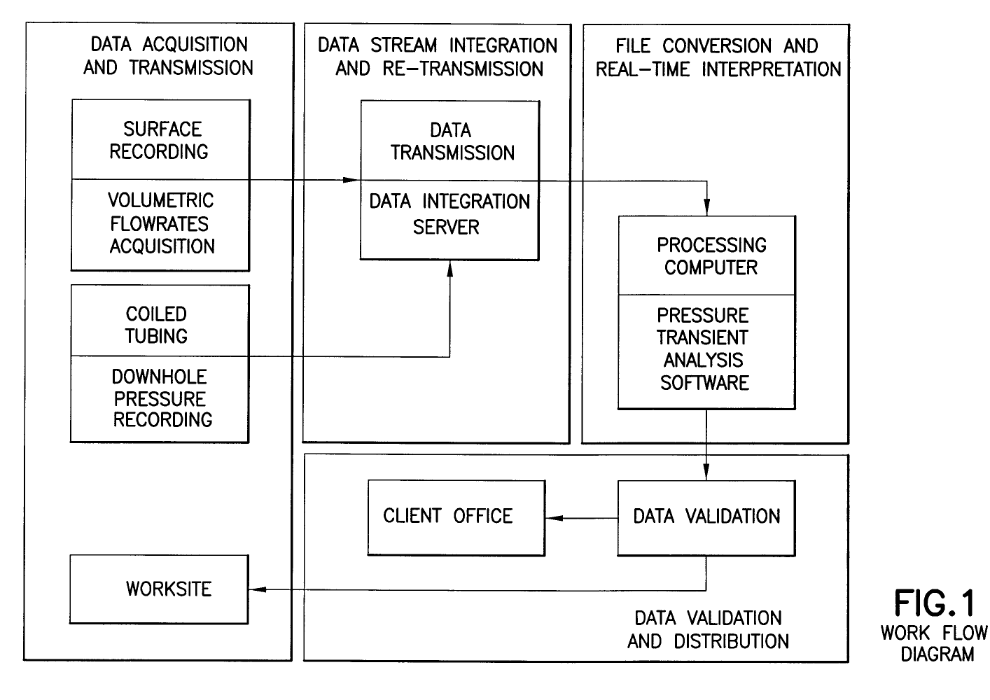

FIG. 1 shows one example embodiment of the data workflow. The flow rate and bottomhole pressure measurements are transmitted in near real-time to a server where the data is integrated and further transmitted to a processing station. The processing station has software capable of analyzing the Pressure Transient and calculating a property of the tested formation, such as the skin or permeability, and generating a report. The data is then transmitted and validated and further transmitted to both the client office and worksite. After the formation is treated by pumping fluid (such as acidizing or fracturing fluid) into the formation using the coiled tubing, this process can be repeated and an updated property of the formation (such as final skin) can be determined.

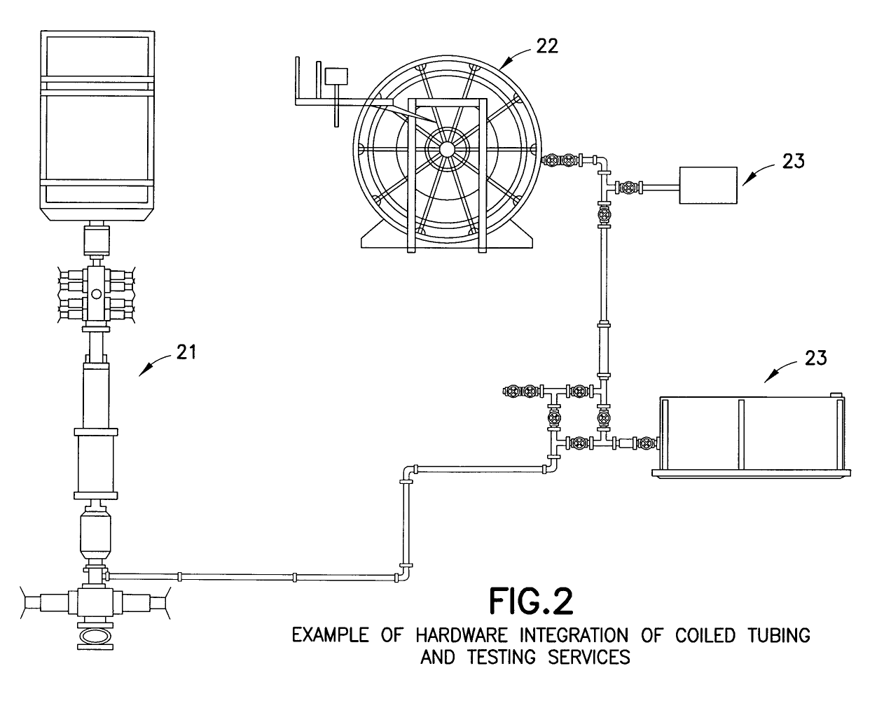

FIG. 2 shows an example of the integration of hardware equipment from Coiled Tubing and Testing Services. The coiled tubing unit 22 and the coiled tubing pressure equipment 21 are integrated with and connected to the surface well testing equipment 23. During well testing operations, reservoir fluid will travel through the coiled tubing string, through the coiled tubing pressure equipment 21, through the coiled tubing unit 22, and into the surface well testing equipment 23, where the flow rate is measured.

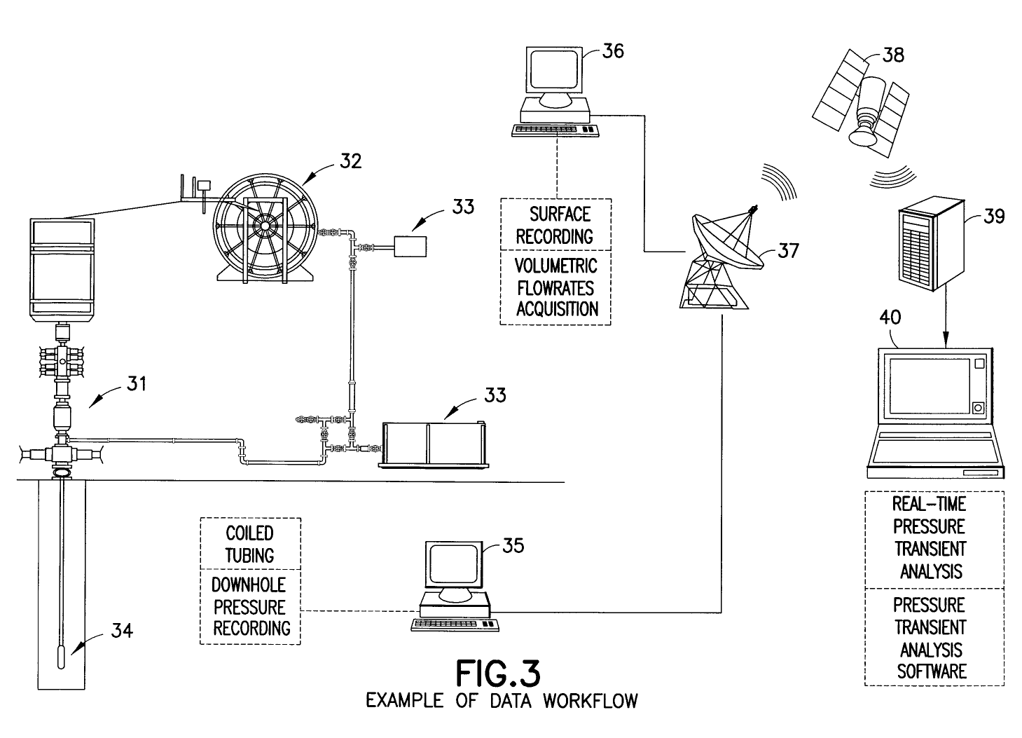

FIG. 3 shows one embodiment of the present invention where the data flow is depicted. The data recorded by the one or more downhole pressure sensors 34 lowered into the well by a coiled tubing unit 32 is stored in a coiled tubing processing unit 35 and the data from the surface well testing equipment 33 is stored in a well testing processing unit 36. Both data sets, from the coiled tubing sensor(s) and the well testing equipment, are transmitted to a server 39. This transmission can be achieved, as an example but not to limit this disclosure, by a satellite transmitter 37 to a satellite 38 for further transmission to server 39. Server 39 collects, stores, integrates and re-transmits the data from the downhole pressure sensor(s) and the surface well testing equipment to a processing unit 40 where a property of the formation is determined and a report is typically generated. The report may then be distributed.

While the invention is described through the above exemplary embodiments, it will be understood by those of ordinary skill in the art that modification to and variation of the illustrated embodiments may be made without departing from the inventive concepts herein disclosed. It would be possible, for instance, to locate the data integration server and/or the processing computer locally at the worksite. Similarly, it is possible to perform the functions required of both the data integration server and the processing computer on a single computer system. Moreover, while the preferred embodiments are described in connection with various illustrative processes, one skilled in the art will recognize that the system may be embodied using a variety of specific procedures and equipment and could be performed to test various types of reservoir intervals. Accordingly, the invention should not be viewed as limited except by the scope of the appended claims.

1. A method of calculating a property of a formation using one or more sensors lowered into a well on coiled tubing and surface well testing equipment, comprising:
i. recording flow rate data measured using said surface well testing equipment;
ii. recording downhole pressure data measured using said one or more sensors lowered into a wellbore penetrating said formation on said coiled tubing;
iii. transmitting said flow rate and downhole pressure measurements to a server, wherein said server is capable of collecting, storing and retransmitting said measurements; and
iv. transmitting said measurements to a processing unit, wherein said processing unit analyzes said measurements and calculates a property of the formation.

2. A method as in claim 1, wherein said property of the formation is skin or permeability.

3. A method as in claim 1, wherein said property of the formation is included within a report.

4. A method as in claim 3, further comprising the step of validating said report.

5. A method as in claim 3, further comprising the step of transmitting said report to the worksite and client office.

6. A method as in claim 3, wherein an updated report is transmitted periodically at a predetermined time.

7. A method as in claim 1, wherein the analysis of the measurements is done by the pressure transient analysis method.

8. A method as in claim 1, wherein the measurements of the one or more downhole pressure sensors and the surface well testing measurements are integrated in said server.

9. A method as in claim 1, wherein the measurements of the one or more downhole pressure sensors and the surface well testing measurements are integrated at the worksite before being transmitted to the server.

10. A method as in claim 1, wherein the measurements of the one or more downhole pressure sensors and the surface well testing measurements are integrated in the processing unit.

11. A method as in claim 1, wherein said transmitting comprises the use of one or more of the following means of data transmission: satellite, internet, wireless, or solid media.

12. A method as in claim 1, wherein the measurement data is translated to wellsite information transfer standard markup language format.

13. A method as in claim 1, wherein the measurement data stored in the server can be accessed anywhere in the world that has network connectivity.

14. An apparatus for calculating a property of a formation comprising:
i. a coiled tubing unit having one or more downhole pressure sensors capable of being lowered into a wellbore;
ii. surface well testing equipment capable of measuring flow rate data;
iii. means for transmitting downhole pressure and flow rate measurements to a server capable of collecting, storing, and retransmitting the measurement data; and
iv. means for transmitting the measurements to a processing unit capable of calculating the property of the formation.

15. A method of servicing a hydrocarbon well using one or more pressure sensors lowered into a well on coiled tubing and surface well testing equipment, comprising:
i. determining a property of a formation using flow data measured using said surface well testing equipment integrated with pressure data measured using said one or more sensors lowered into said well penetrating said formation on said coiled tubing;
ii. treating said formation by pumping fluid into said formation using said coiled tubing; and
iii. repeating said determining of said property of said formation using flow data measured using said surface well testing equipment integrated with pressure data measured using said one or more sensors lowered into a wellbore penetrating said formation on said coiled tubing;
wherein said coiled tubing remains deployed within said well throughout said determining, treating, and repeating said determining processes.

16. A method of servicing a hydrocarbon well in accordance with claim 15, wherein said property of said formation determined in process i) is included within a report that is created prior to process ii).

17. A method of servicing a hydrocarbon well in accordance with claim 15, wherein one or more process parameters in said treatment process ii) is determined based on said property of said formation determined in process i).
